(19) United States
(12) Patent Application Publication
(10) Pub. No.: US 2014/0164012 A1
(43) Pub. Date: Jun. 12, 2014

(54) SYSTEM AND METHODS FOR SIMULATING FUTURE MEDICAL EPISODES

(71) Applicants: Noel GUILLAMA, Wellington, FL (US); Chester HEATH, Boca Raton, FL (US); Jahziel M. GULILLAMA, Wellington, FL (US)

(72) Inventors: Noel GUILLAMA, Wellington, FL (US); Chester HEATH, Boca Raton, FL (US); Jahziel M. GULILLAMA, Wellington, FL (US)

(21) Appl. No.: 14/182,434

(22) Filed: Feb. 18, 2014

Related U.S. Application Data
(63) Continuation-in-part of application No. 12/535,523, filed on Aug. 4, 2009, now Pat. No. 8,666,766.
Application No. 12/535,523 is a continuation-in-part of application No. PCT/US2012/052404, filed on Aug. 25, 2012.
(60) Provisional application No. 61/086,609, filed on Aug. 6, 2008.
(60) Provisional application No. 61/527,287, filed on Aug. 25, 2011.

(51) Int. Cl. G06F 19/00

(52) U.S. Cl. CPC G06F 19/3431
USPC 705/2

(57) ABSTRACT

Computer-based systems and methods for managing individuals with respect to medical episodes are provided. In the systems and methods, affinity groups for a population and the connections between such affinity groups are identified. Based on the groups associated with a medical episode, recommendations can be provided to individuals in order to avoid or spread the effect of medical episodes to other individuals.

### CROSS-REFERENCE TO RELATED APPLICATIONS

This application is a continuation-in part of U.S. Non-Provisional application Ser. No. 12/535,523, which was filed Aug. 4, 2009 and which claims the benefit of U.S. Provisional Patent Application No. 61/086,609 filed on Aug. 6, 2008, and International Patent Application No. PCT/US2012/52404, which was filed Aug. 25, 2012 and which claims the benefit of U.S. Provisional Patent Application No. 61/527,287 filed Aug. 25, 2011. The contents of each of the foregoing applications are hereby incorporated herein in their entireties.

### FIELD OF THE INVENTION

The present invention is related to the field of data processing, and more particularly, to systems and method of predicting the future wellness of an individual or a patient.

### BACKGROUND OF THE INVENTION

A significant challenge facing healthcare professionals endeavoring to maintain a patient's health is to convince the patient of potential medical outcomes stemming from the patient's behavior and lifestyle. Indeed, not a few health experts have ranked lifestyle as an even greater determinant of health and wellness, long term at least, than genetics, heredity, and family histories combined. To be convinced, though, the patient must accurately perceive the potential outcomes, the probabilities of the potential outcomes, and the factors that make each more or less likely.

With respect to even a single patient, providing a statistically-defensible predictions of possible health outcomes typically requires the collating and assessment of health-related medical and lifestyle information. Such information, even individual-specific information, can be generated over long periods and, usually, is extraordinarily voluminous. Typically, the information is only obtainable from disparate sources.

Today there is not an effective and efficient technique for providing lifestyle alternatives simulations. It is thus often difficult to provide to the patient a compelling picture that lays out the need to alter one or more lifestyle factors. Many, if not most, patients typically exist in at least a partial state of denial over the importance of such factors. This tends to be especially true with younger patients noted for misconstruing youth as absolute invulnerability. The absence of techniques for making complex mathematical and statistical evaluations of such information also precludes opportunities to discover unknown maladies, whether created by nature or caused by man-made factors. That is there are no effective and efficient mechanisms for generating predictive analyses based on lifestyle and medical histories possibly prevents the uncovering of hidden maladies. Moreover, there do not yet exist effective and efficient mechanisms for generating models of wellness based on such factors, let alone any mechanism for fine tuning such models based upon iteratively-applied feedback.

### SUMMARY OF THE INVENTION

In view of the foregoing background, it is therefore a feature of the invention to provide systems and methods for providing medical episodic simulations. One aspect of the invention is the computer-based implementation of techniques for simulating and/or predicting future medical episodes pertaining to an individual or patient. As described herein, such simulations and predictions can be based on complex mathematical and/or statistical comparisons of wellness data specific to the individual or patient with data pertaining to numerous other similarly-situated individuals. Thus, statistically-defendable and valid predictions can be generated. Accordingly, the future health and wellness of the individual or patient can be estimated with a degree of confidence.

Another aspect of the invention is the generation, through simulation, of a compelling picture of what the individual's or patient's future health is likely to be given the individual's or patient's current wellness and lifestyle. Another aspect is the generation of a model of the individual's or patient's wellness. The model can be fine tuned using one or more feedback loops to elucidate outcomes likely to follow by the individual or patient following or not following the advice of a professional healthcare giver. Still another aspect of the invention is the integration of disparate medical and non-medical data from a wide array of data sources so as to readily identify disease patterns.

One embodiment of the invention is a computer-based system for generating future medical episodic simulations. The system can include at least one processor comprising logic-based circuitry for processing data according to a set of stored instructions. The system also can include a signature-generating module configured to execute on the at least one processor for generating a personal wellness lifestyle signature for an individual based upon pre-selected data pertinent to wellness of the individual. Additionally, the system can include a comparing module configured to execute on the at least one processor for comparing the personal wellness lifestyle signature of the individual with at least one personal wellness lifestyle signature of at least one other individual determined to have at least one wellness characteristic similar to a corresponding wellness characteristic of the individual. The system can further include an episode-predicting module configured to execute on the at least one processor for predicting at least one future medical episode corresponding to the individual based upon the comparison.

Another embodiment of the invention is a computer-implemented method of generating future medical episodic simulations. The method can include generating a personal wellness lifestyle signature for an individual based upon pre-selected data pertinent to wellness of the individual. The method also can include comparing the personal wellness lifestyle signature of the individual with at least one personal wellness lifestyle signature of at least one other individual determined to have at least one wellness characteristic similar to a corresponding wellness characteristic of the individual. The method can further include predicting at least one future medical episode corresponding to the individual based upon the comparison.

Yet another embodiment of the invention is a computer-readable medium in which is embedded computer-readable code, defining a computer program, that when loaded on a computer causes the computer to perform the following steps: generating a personal wellness lifestyle signature for an individual based upon pre-selected data pertinent to wellness of the individual; comparing the personal wellness lifestyle signature of the individual with at least one personal wellness lifestyle signature of at least one other individual determined to have at least one wellness characteristic similar to a corresponding wellness characteristic of the individual; and predicting at least one future medical episode corresponding to the individual based upon the comparison.

In yet another embodiment of the invention, computer-based systems and methods for managing individuals with respect to medical episodes are provided. In the systems and methods, affinity groups for a population and the connections between such affinity groups are identified. Based on the groups associated with a medical episode, recommendations can be provided to individuals in order to avoid or spread the effect of medical episodes to other individuals.

### BRIEF DESCRIPTION OF THE DRAWINGS

There are shown in the drawings, embodiments which are presently preferred. It is expressly noted, however, that the invention is not limited to the precise arrangements and instrumentalities shown in the drawings.

FIG. 1 is a schematic view of a system for generating future medical episodic simulations, according to one embodiment of the invention.

FIG. 2 is a schematic view of an exemplary data structure utilized by the system illustrated in FIG. 1.

FIG. 3 is a schematic view of an exemplary personal wellness lifestyle signature (PWLS) generated and utilized by the system illustrated in FIG. 1.

FIG. 4 is a schematic view of a wellness modeler, including feedback loop, according to another embodiment of the invention.

FIG. 5 is a schematic view of a representative PWLS.

FIG. 6 is a schematic view of a representative PWLS.

FIG. 7 is a plot contrasting selected characteristic of users of N-methyl-4-phenyl-1,2,3,6 tetrahydropyridine (MPTP).

FIG. 8 is a PWLS incorporating characteristics corresponding to the plot of FIG. 7.

FIG. 9 is a flowchart of exemplary steps in a method for generating future medical episodic simulations, according to still another embodiment of the invention.

FIG. 10 shows an exemplary ESN map, illustrating available career locations for individuals that grow up in a geographic area, in accordance with an embodiment of the invention.

FIG. 11 shows an exemplary “health connectivity map” that is useful for tracking development of a disease in accordance with an embodiment of the invention.

FIG. 12 is a flowchart of steps in an exemplary method for advising individuals in accordance with an embodiment of the invention.

FIG. 13 is a flowchart of steps in an exemplary method for managing a population in accordance with an embodiment of the invention.

FIG. 14 shows the collection of healthcare metadata by an Integrated Managed Service Organization.

FIG. 15 shows an application of traditional ESN concepts to tracking wellness attributes as affinity groups by PWLS's.

### DETAILED DESCRIPTION

The present invention is directed to systems and methods providing medical episodic simulations. Such systems and methods can implement, for example, techniques by which lifestyle alternatives can be simulated for predicting future medical episodes pertaining to an individual or patient. These simulations and predictions, moreover, can be based on complex mathematical and/or statistical comparisons of individual-specific wellness data of the individual or patient with those of numerous other similarly-situated individuals so as to generate statistically-defendable and valid predictions. Accordingly, in various embodiments of the invention, future health and wellness of the individual or patient can be estimated with a degree of confidence.

The system and methods also can be used to generate for the individual, through the simulation, a compelling picture of what the individual's or patient's future health can be expected to be given the individual's or patient's current wellness and lifestyle. The system and methods can, additionally or alternately, generate a model of the individual's or patient's wellness. Moreover, the model can be fine tuned using one or more feedback loops to elucidate outcomes likely to follow by the individual or patient following or not following professional medical advice. The system and methods, additionally or alternately, can be used to integrate disparate medical and non-medical data from a wide array of data sources to identify disease patterns.

System Aspects

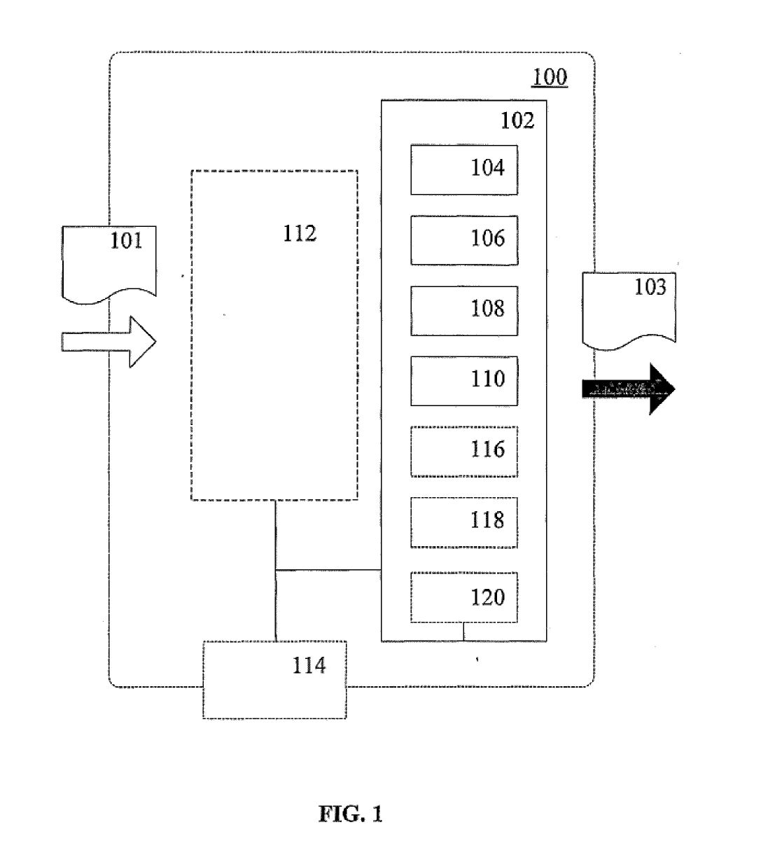

FIG. 1 is a schematic diagram of a computer-based system 100 for generating future medical episodic simulations, according to one embodiment of the invention. The system 100 illustratively includes one or more processors 102. As will be readily apparent to one of ordinary skill, the one or more processors 102 can be implemented in a single computing device or distributed among several devices that in the aggregate define a distributed system. The one or more processors can comprise registers, logic gates, controllers and other logic-based processing circuitry (not explicitly shown).

Illustratively, the system 100 further includes a signature-generating module 104, a signature-generating module 106, a comparing module 108, and an episode-predicting module, 110 each configured to execute on the one or more processors 102 for performing the procedures, processes, and functions described herein. One or more of the signature-generating module 104, a signature-generating module 106, a comparing module 108, and an episode-predicting module 110 can be implemented as a combination of logic-based processing circuitry and processor-executable code, such as computer code configured to execute on a general purpose or application-specific computing device. In an alternative embodiment, however, one or more of the signature-generating module 104, a signature-generating module 106, a comparing module 108, and an episode-predicting module 110 can be implemented in hardwired dedicated circuitry configured to function cooperatively with a computing device for performing the same or similar procedures, processes, and functions

As illustrated, the system 100 optionally includes one or more memory elements 112 communicatively linked to the one or more processors 102 for storing processor-executable instructions and/or data for processing according to the instructions. Illustratively, the system 100 further includes one or more input/output (I/O) devices 114, such as a keyboard, computer monitor, and/or computer mouse to enable a user to enter data, receive output.

Although illustratively shown as co-located with the one or more processors 102 within the system 100, in alternate embodiments, the one or more memory elements 112 like the one or more processors can be distributed at one or more remote sites forming a distributed environment. Accordingly, the one or more I/O devices 114 can comprise a network interface for communicatively link various remote sites through a network or interconnection of networks, such as the Internet.

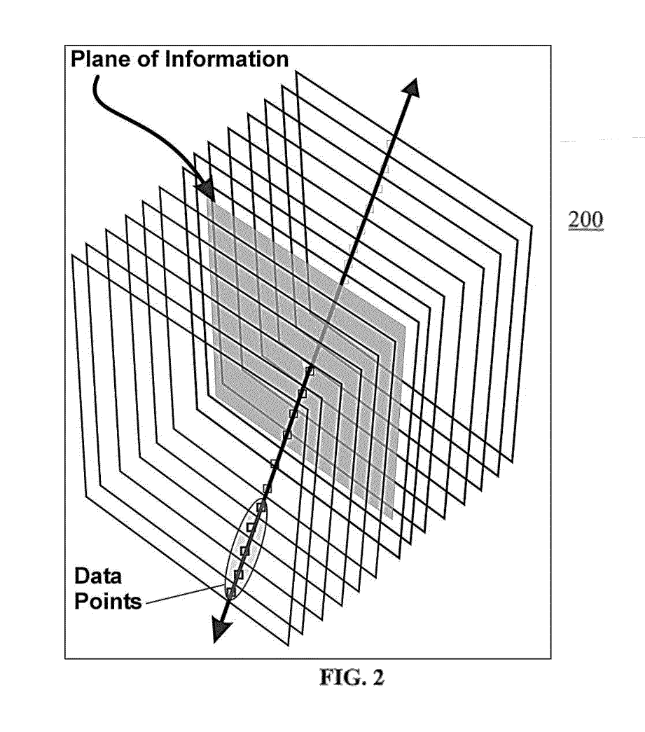

A particular aspect of the system 100 is the generation and utilization of a personal wellness lifestyle signature (PWLS), which is described more particularly below. Over an individual's lifetime, an enormous quantity of medical and lifestyle information is generated pertaining to the individual. As described more particularly below, the system 100 can integrate and organize hyper-complex information generated over extended periods of time into a coherent data structure. Referring additionally to FIG. 2, an exemplary data structure is shown. The data structure 200 comprises a plurality of N-dimensional arrays (identified by the planes of information comprising multiple data points). Each such array can be parsed according to different pre-determined perspectives so as to generate reports pertinent to various disciplines. Additionally or alternatively, each such array can be mined to discover trends and associations, or reduced to any required level of understanding.

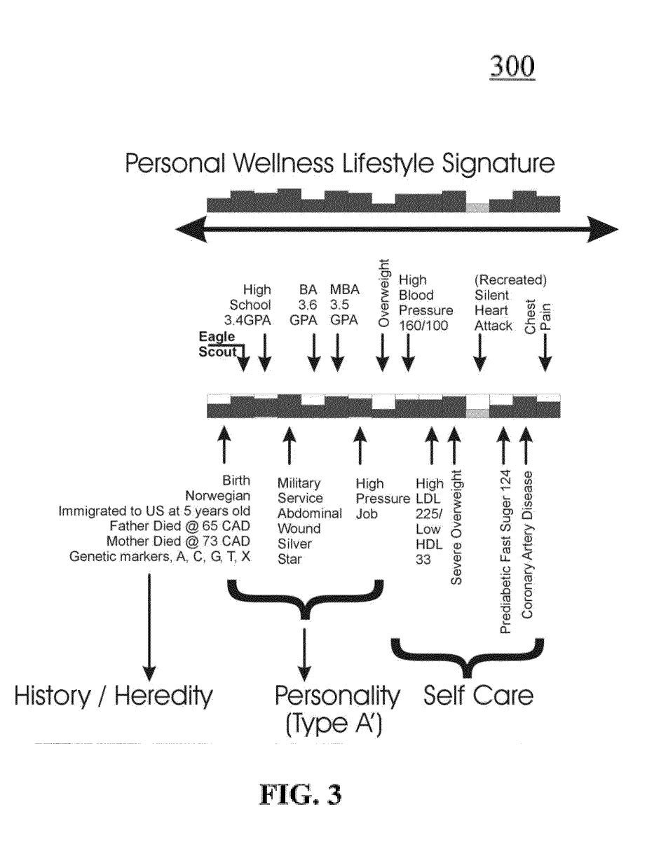

One such report so generated by the system 100 is a PWLS for an individual or patient. Referring additionally to FIG. 3, an exemplary PWLS for a individual is shown. The PWLS can comprise and be integrated with various types of information so as to gain insight into the corresponding individual's health, lifestyle, and any other wellness-relevant information. Thus, the PWLS is an ideal vehicle for integrating various factors such as heredity, family history and the like. The PWLS can include various other factors as well, such as genetic markers and developmental attributes (e.g., birth weight and APGAR scores). Additionally, as described more particularly below in the context of the operative aspects of the system 100, data not conventionally considered medical can be mined to infer information where no specific data is available or testing has been performed. Though, illustrated as bar-chart values, it is to be noted that, in fact, each point of the PWLS comprises a vector having multiple dimensions that can compared to other vectors accurately and expeditiously using the computer-based system 100.

Referring specifically to FIG. 1, again, certain operative features of the invention are now described. Operatively, the signature-generating module 104 is configured to generate a personal wellness lifestyle signature for an individual based upon received, pre-selected data 101 pertinent to wellness of the individual. The comparing module 106 compares the personal wellness lifestyle signature of the individual with at least one personal wellness lifestyle signature of at least one other individual determined to have at least one wellness characteristic similar to a corresponding wellness characteristic of the individual. The episode-predicting module 108 generates a prediction 103, predicting at least one future medical episode corresponding to the individual based upon the comparison performed by the comparing module 106.

Optionally, the system 100 also can include an identifying module 116 configured to execute on the at least one processor 102. The identifying module 116 can be configured to identify the at least one other individual. More particularly, the identifying module 116 can be configured to identify the at least one other individual by determining a statistical correlation between the at least one wellness characteristic of the at least one other individual and the corresponding wellness characteristic of the individual. In a particular embodiment, the identifying module 116 can be configured to compute the statistical correlation by computing a value of a correlation coefficient and comparing the computed correlation coefficient to a predetermined level of similarity.

The system 100 can optionally, either additionally or alternatively, include a data mining module 118 configured to execute on the one or more processors 102. The data mining module 118, more particularly, can perform one or more data mining procedures so as to identify data indicative of the wellness of the individual. The data mining module 118 can be configured to perform data mining on one or more data sets. The data sets can include, for example, environmental data, lifestyle data, medical history data, and/or medical data.

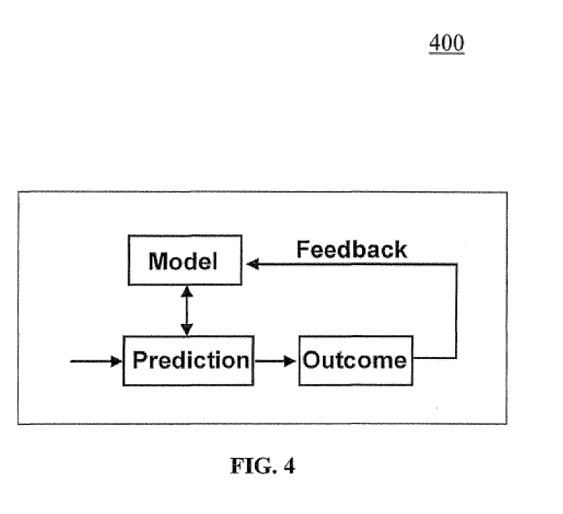

Optionally, the system 100 can additionally or alternately, include a wellness modeler 120 configured to execute on the one or more processors 102. The wellness modeler 120 can be configured to generate a model of the wellness of the individual. The model so generated by the wellness modeler 120 can be based upon at least one among a lifestyle history of the individual, a medical history of the individual, and past medical episodes of the individual. According to a particular embodiment comprising the wellness modeler 120, the system 100 can further include a feedback loop configured to refine the wellness model, as schematically illustrated in FIG. 4.

According to a particular embodiment, the wellness modeler 120 is configured to generate a statistical model. The wellness modeler 120, moreover, can be is configured to generate the statistical model by determining at least one factor weights.

### EXAMPLE SCENARIOS

### Example 1

Operative aspects of the invention can be illustrated by example. Assumed in this example is an individual, Jon Docowitz, who was born to a family with a history of coronary artery disease and whose parents lived less than a normal lifespan. Jon was a high achiever from an early age, overcoming a language impairment (starting school speaking only a foreign language) to attain high grades, Eagle Scout, and a graduate degree with honors. He was also a decorated war hero, whose military record shows extraordinary drive. Jon was headed for success, but most likely a Type A personality headed for heart disease as well.

Jon's occupation placed continuous emotional stress on his body. The body reacted with high blood pressure. He gained weight; his blood chemistry showed the effects of stress and poor diet as he gained even more. Later results imply a silent heart attack sometime between two physical exams. Eventually his sugar tolerance indicated he was pre-diabetic; he was diagnosed with coronary artery disease and suffered chest pain. H is physician, seeing the inevitable, advised him to lose weight, exercise, change his diet, and change his occupation. In denial, Jon sees a promotion near and says he does not have time to take care of himself. He asks for some pills to make his symptoms go away.

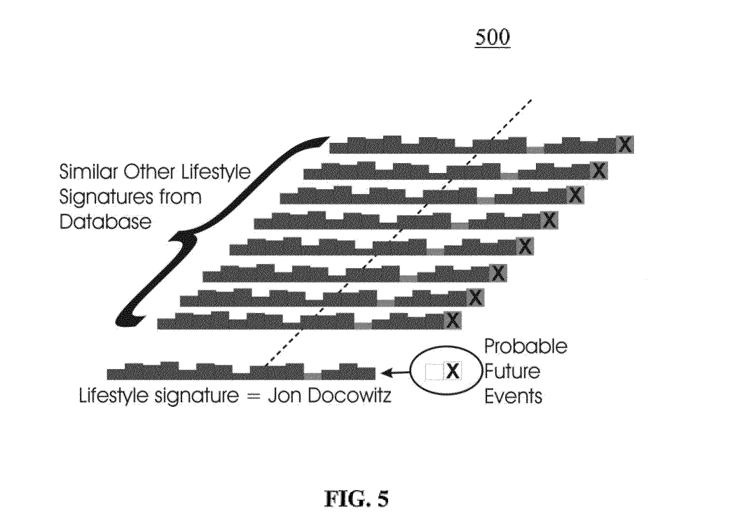

Normally, the physician would not have tools to break down the denial. However, in this case, he does. “Mr. Docowitz, I took the liberty of ordering a report from a service that compares your lifestyle to others like you. Of nearly 130 million people, while none can match your military record, 7,225 individuals had lifestyles that correlated within 99.3% to yours—up to this point. They are all now dead!” The future medical episodic simulation relied on by the physician was generated by the system 100 described. The system 100 generated the exemplary PWLS 500 shown in FIG. 5

Continuing, the physician informed Jon that “based on their histories, the report suggests within a certainty of 70% that you will have a major heart attack sometime between 14 and 16 months from now. A second one will kill you shortly afterward. However, if you follow our advice your lifestyle will fall into another group of patients who listened to their doctors and lived an average of an additional 22 years. Now do you want that promotion enough to die for it?”

### Example 2

Another example assumes a representative individual, Bette Dia, who began singing at age 4. By 16, blue eyed and frail, she was a graduate of Juilliard, a student at NYU and already quite a popular vocalist in jazz clubs about the City. Only casual exploitation of her talent made her a celebrity, well paid and indeed entitled to the best in food and drink wherever she performed, with little criticism as to her lifestyle and escapades. Her eventual rotund figure only enhanced her image as an artist. Yet, when, her nightlife was limited by increasing tiredness, her thirst increased and her vision blurred, her doctor was the first ever to criticize her lifestyle. She was not yet diabetic, but on her way. She had to give up some of the fruits of the good life or have much less life to live overall. It was not easy for a person used to living her way.

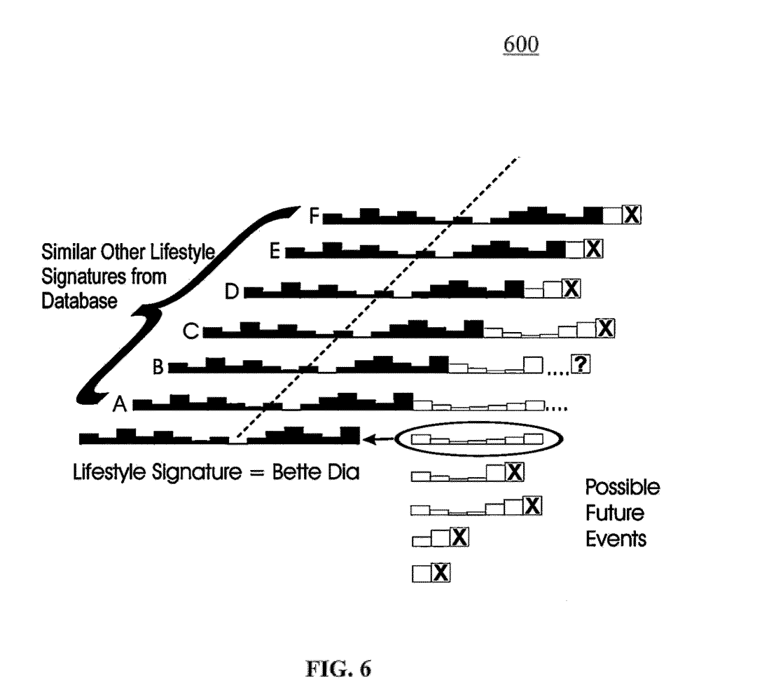

Using an embodiment of the above-described system 100, Bette's doctor was able to show statistical alternatives; the disease was potentially avoidable and perhaps reversible to a normal life expectancy as with group A. The disease could be controlled, but potentially even a simple wound or other unanticipated complication could still lead to a wellness decline as with group B. Typically, a commitment to lifestyle change should lead to a significant extension of lifespan as in group C. Yet, without 2 hours of exercise per week, less than 30 percent of calories from fat and a loss of 7% weight within a year, she would fall into groups D through F. Almost certainly she would lose her 4-octave voice. Operatively, the system 100 can generate for Bette and her physician the exemplary PWLS 600 illustrated in FIG. 6. In response to the compelling picture provided, Bette is today known as the skinny soprano.

### Example 3

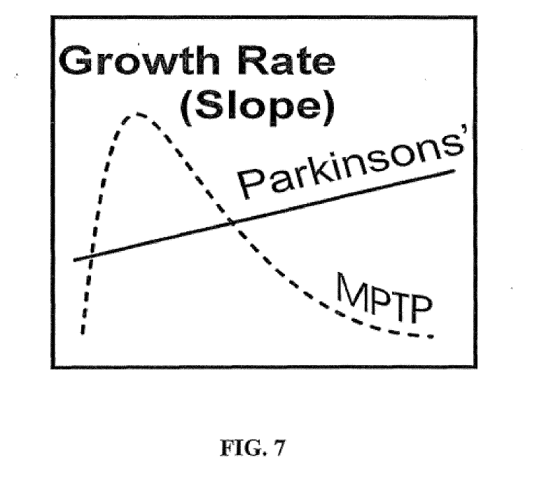

Yet another example corresponds to actual events. Having been developed in a home laboratory, unknown and as yet unclassified by the DEA, a potent variation of the pain killer Demerol was legally available as a street drug. A contaminant in the homebrew narcotic called N-methyl-4-phenyl-1,2,3,6-tetrahydropyridine or (MPTP) was leading to near instantaneous destruction of a part of the brain that gates muscular control of the body. The symptoms of apparent total paralysis were nearly identical to advanced Parkinson's disease, yet the victims were in their teens and 20s rather than late in life. Indeed, there was no correlation between young and old lifestyle signatures, except all the young victims were street drug users. They also responded to L-Dopa treatment, as if they had advanced Parkinson's paralysis. And the growth slope of MPTP incidents was high initially and tapered off later perhaps as word spread among the street community of the bad drugs. (See FIG. 7.) The experience was repeated in northern California, Md. and British Columbia all with the same characteristic growth curve. Several people would eventually die or be paralyzed for life.

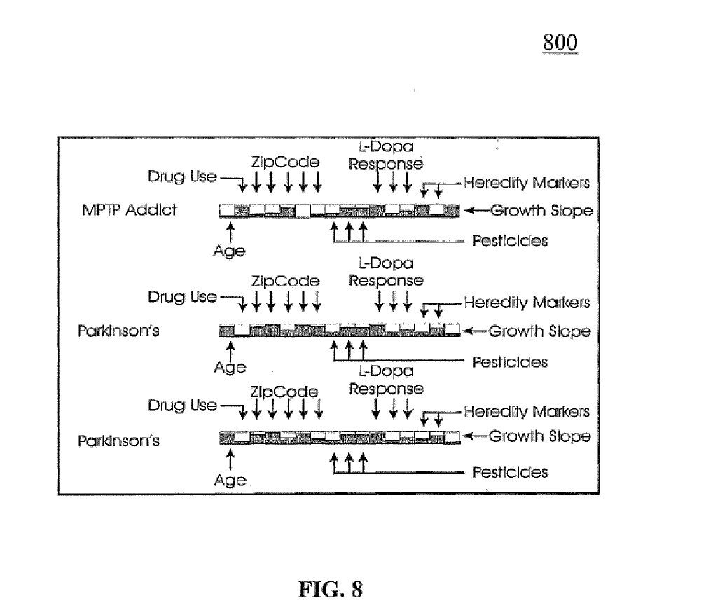

Statistical analysis of the lifestyle signatures of the older victims showed that true Parkinson's victims were 3 times more likely to acquire Parkinson's paralysis, if they lived much of their life at a zip code near a paper mill, 3 times more likely if they lived in rural agricultural zip codes—rather than a city, and 9 times more probable if they lived in both areas. Further statistical analysis showed that there were no recorded incidents of Parkinson's prior to 1910. The system 100 described above provides an all-inclusive, effective and efficient mechanism for obtaining the analysis. An exemplary PLWS 800 corresponding to the described scenario is shown in FIG. 8.

True Parkinson's was apparently an environmental disease, where MPTP was a mass poisoning. The street drug dealer was identified by victims who regained the ability to speak and move with Parkinson's treatments and removed from society when signatures of victims in a new zip code showed the high slope characteristic of the initial phase of distribution.

As already described the processes, procedures and functions implemented by the above-described system 100, utilize PWLSs, combined with other statistical evidence, so as to identify the trend and predict an outbreak rapidly and for much less cost. Further, the statistical associations to Parkinson's paralysis by geography and/or heredity and environmental factors came afterward, only because researchers knew to look for an environmental- or chemical-based causality factor. Otherwise the causes of Parkinson's might be much less understood now.

More generally, the system 100 provides a mechanism for predictive analysis of the medical history to identify and predict trends pertaining to maladies, whether created in nature or in response to man-made conditions. As already noted, an optional aspect of the system is a mechanism to utilize feedback on the data so as to optimize health-related models. Rather than simple comparison, factors can be heuristically weighted with experience to increase the validity of the simulations and estimations generated by the system 100.

### Example 4

In some embodiments, the concepts of Episodal Social Networks (ESNs) can be applied, as described in International Patent Application No. PCT/US2012/052404, filed Aug. 25, 2012, the contents of which are herein incorporated by reference in their entirety. ESNs differ from the concept of traditional social networks that assume a continuum or timeline. The ESN concept asserts that groups which have some affinity can be linked serially, conditionally and may be ephemeral, or long lasting by nature. These groups that share some attribute are called “Affinity Groups”.

ESNs attempt to more accurately minor the true behavior of humans, where interests change, friendships and commitments change in often sequential but complex ways such that we can become members of various affinity groups temporarily, sporadically, or permanently. There are decision points that become the inflection points on the curve of experience defining both concurrent as well as monotonic paths. These points can alter the path of future corridors and can be voluntary, random, or under the influence of external forces. Understanding this nature of selective sequence allows ESNs to be used to analyze, understand, simulate and potentially influence life decisions. Thus, ESNs can be used to explain causes of healthcare issues and potentially control healthcare of individuals.

Consider in the above Example 3 that Parkinson's Disease is found to be a cumulative effect of exposure to MPTP in the areas near paper mills and fertilizer manufacture or use in agriculture. If one were to be a member of an affinity group that lived in an agricultural area, and then moved to an area of paper mills and farms, one might contract Parkinson's earlier rather than later. Looking at the problem using the ESN perspective, this means that prolonged membership in affinity groups associated with such localization might be detrimental to one's health. On the other hand, by selecting to move to a desert or a maritime climate, i.e, becoming a member of an affinity group that does not lead to prolong exposure, might allow one to live a normal life without accumulating MPTP in significant amounts.

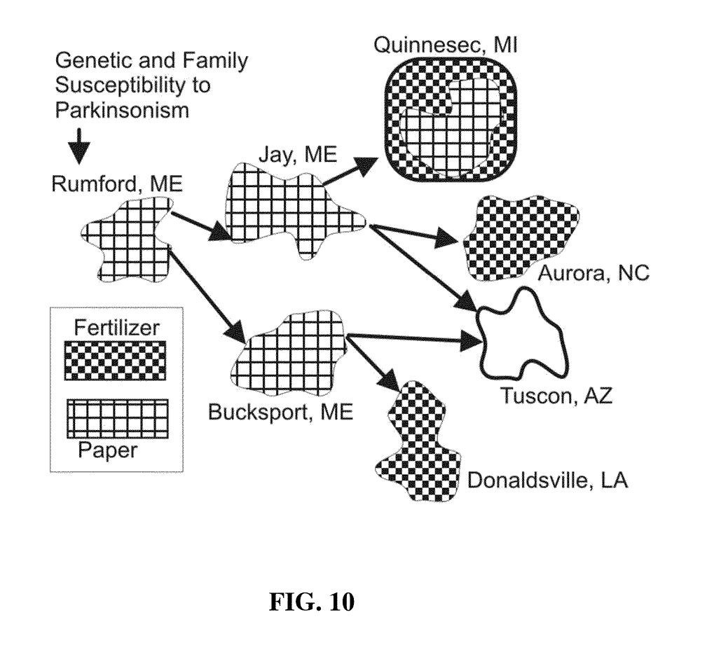

This concept is illustrated with respect to FIG. 10. FIG. 10 shows an ESN map of available career locations for individuals that grow up in Rumsford, Me. As shown FIG. 10, an individual would have the option of a first job in Jay, Me. and Bucksport, Me. From Jay, Me. The individual would have the option of a next job in Quinnesec, Mich., Aurora, N.C., or Tucson, Ariz. From Bucksport, Me., the individual would have the option of a next job in Aurora, N.C., Tucson, Ariz., or Donaldsville, La. Overlain with the locations in FIG. 10, is an indication of the types of exposure. For example, Rumsford, Me. is an area riddled with paper mills. Similarly, Jay, Me. and Bucksport, Me., are also towns with also with competing paper mills. Aurora, N.C. and Donaldsville, La. are areas of heavy fertilizer use. Quinnesec, Mich. is an area of heavy fertilizer use, as well as including paper mills. Tucson, Ariz. includes neither paper mills nor is an area of heavy fertilizer use.

Based on this information, an advisor service can be provided to individuals, particular those with a genetic or family predisposition to Parkinson's Disease, that provides advice to cause the individual to eventually move out of his high risk area in order to improve his health. However, the process is not simply to advise the individual to move out, but to assist the individual by leading the individual along potential paths to careers in a Parkinson's “clean” area (i.e., Tucson, Ariz.). For example, the advisor service can advise with respect to career growth and education opportunities that will lead the individual along the potential paths to the “clean” areas.

Assuming access to a wide range of facts, an ability to predict business opportunities, and the ability to plan logical decisions, much as a computer might play chess, the advisor service can be configured to predict when the individual can, or will need to, make a decision regarding his career and, more importantly, what information, assets, education, etc., that the individual will need to make the decision. Specifically, the decision to lead him along a preferred path.

For example, if one had lived for a sufficient period in a high risk area, the onset of Parkinson's might be delayed or eliminated by residing in a low risk areas thereafter. Accordingly, in the case of FIG. 10, an individual would be guided along a path leading to a job in Tucson, Ariz. Thus, for an individual taking the first Job in Jay, Me., the advisor service would indicate that there is a nearby college, offering courses toward degrees that can offer qualification to transfer within the company to Quinnesec, Mich., or a career jump to Aurora, N.C. or Tucson, Ariz. As noted above, Aurora is an area replete with fertilizer manufacturing and Quinnesec offers exposure to both fertilizer use and paper manufacturing. However, the education advice also provides a path to a job in Tucson, Ariz., a “clean” area. In another example, the goal might be to avoid exposure to both paper manufacture and heavy fertilizer use. Thus, since two of the three options from Jay, Me. result in both types of exposure and only one option from Bucksport, Me. results in both types of exposure, the advisor service can provide advice to lead to a career path from Rumford through Bucksport, Me., instead of Jay, Me. Although the career path through Bucksport, Me. might still result in a career in Donaldsville, La., the career path has the potential for a career in the “clean” area of Tucson, Ariz.

Although the above-mentioned example was limited to exposure to chemicals, the various embodiments are not limited in this regard. In other embodiments, a similar methodology can be utilized to minimize or mitigate exposure to radiation, other hazardous or harmful chemical and materials (e.g., asbestos), cumulative heavy metal contamination, excessive sun exposure, or any other conditions for which prolonged exposure by location or avocation can be harmful.

### Example 5

Another aspect of the various embodiments is that ESN can be advantageously utilized for the application of recreating the infection path of a communicable disease through one or more groups of people, animals, etc.

In general, metadata from telephone calls, text messaging, instant messaging, email, and other traditional social media can be mined to accurately define a list of friends, family and lessor connected acquaintances. In some cases, this data can also be mined to obtain times and places of contact among such persons. Further, employment or student records can be mined to reveal additional interactions between persons. Mining of credit card spending and locations can indicate additional interactions. Mining could also reveal what recreational affinity groups might exist: dancers, bowlers, exercise—health club members, computer dating, cruise ship passengers, as well as records for arrest, drinking, and drug use leading to affinity groups as well. The data exists to be potentially mined for, who followed who using the same cabs, sat nearby or afterwards in restaurants, and similarly used public and air transportation as well as hotel rooms.

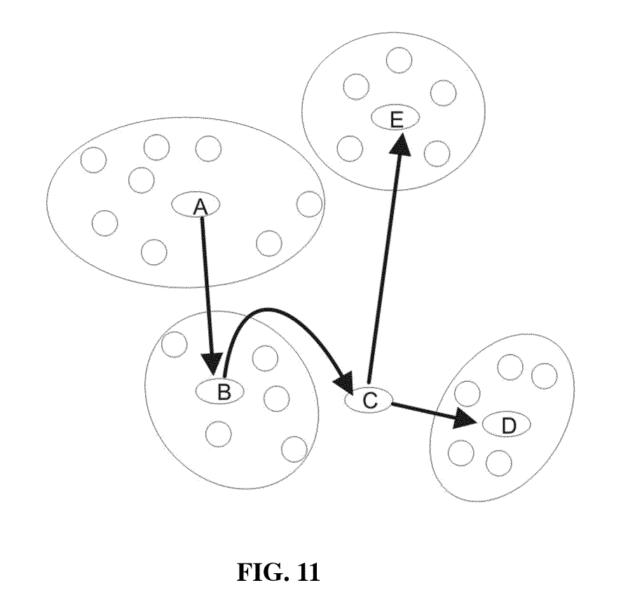

This information, Minable Stored Data (MSD), can be easily mined. However utilizing the MSD is another matter. For example, the MSD data cannot be used to directly identify the epidemiology of communicable diseases and the more probable paths of communication of those diseases within a population without further analyses. Accordingly, the concept of ESNs can be utilized to perform these analyses and provide information for preventing the further spread of the disease. In particular, based on the MSD, affinity groups can be identified, as well as the connections between the affinity groups. Also, based on the gestation period and genetic makeup of the disease, and the dates of occurrence and these connections between probable affinity groups, information such as who shared infection at the same time, or the same place or the same mode, can be inferred. Accordingly, a “health connectivity map” for a disease can then be defined. FIG. 11 shows such a “health connectivity map”.

As shown in FIG. 11, the map consists of affinity groups 1102, 1104, 1106, 1108. Each of these groups includes members represented as circles and oval. In FIG. 11, the ovals are prime connection points (potentially identified by the above mined data and/or genetic markers in the disease). In particular, these can be individuals who have or may infect a circle of nearby peers due to exposure to other affinity groups. For example, the map in FIG. 11 represents an ESN in which a prime connection point can move from A to B to C and thereafter to one of E and D. In some cases, the map may be created after the fact to recreate the distributed medical episode on the population. Alternatively, such maps may be created to define potential modes of communication of disease for interdicting and interrupting the contagion with future diseases.

When the probable prime connection points are identified, these points can be used to provide for accurate vaccination, treatment, and/or quarantine in order halt the spread of a disease. For example, individuals associated with the prime connection points could be pre-inoculated or treated on a priority basis so as to prevent the spread of disease from one affinity group to another. Alternatively, individuals associated with the prime connection points could be prevented from proceeding further along the map to prevent them from infecting other affinity groups. In some cases, this can be done by express prohibiting the individual from joining an affinity group. In other cases, this can be done by establishing conditions to make it preferable for the individual to remain in a current affinity group or to encourage the individual to proceed to an already infected affinity group in order to minimize harm. In a similar fashion, healthy individuals can be dissuaded from joining affinity groups consisting of infected persons.

In some cases, the map can be updated in a dynamic fashion. That is, in addition to the MSD information, individuals may also contribute their wellness status in an ongoing and collaborative fashion. In other words, individuals may voluntarily contribute and correct data in map. Therefore, as people update their health or wellness status on social media sites or via other means, this information can be processed to determine not only update the map, but also to update infection or contamination rates in a building, community, city, country. Potentially, this can be used distribute data to community health leaders, organizations and or medical community.

Accordingly, by studying the development of the map over time, a centralized healthcare database may observe patterns of infection in near real time and label specific pathways as critical connection points and act accordingly. For example, the map may indicate that everyone who rode bus #29 from Hoboken this morning needs an immediate flu shot and that preemptive action could conceivably save a life, interfere with outbreaks of epidemics or pandemics. It could also reveal environmental conditions in a community and generate alerts for humidity, smog, rain, temperature or other environmental situations that could be deleterious to specific sub-groups, such as the elderly or those with breathing conditions. Mining might also reveal traffic DUI patterns such that say at 3 AM on Glades road, a pattern of location, or timing of bars open till 2 AM creates an exposure to heath events (i.e., accidents).

Method Aspects

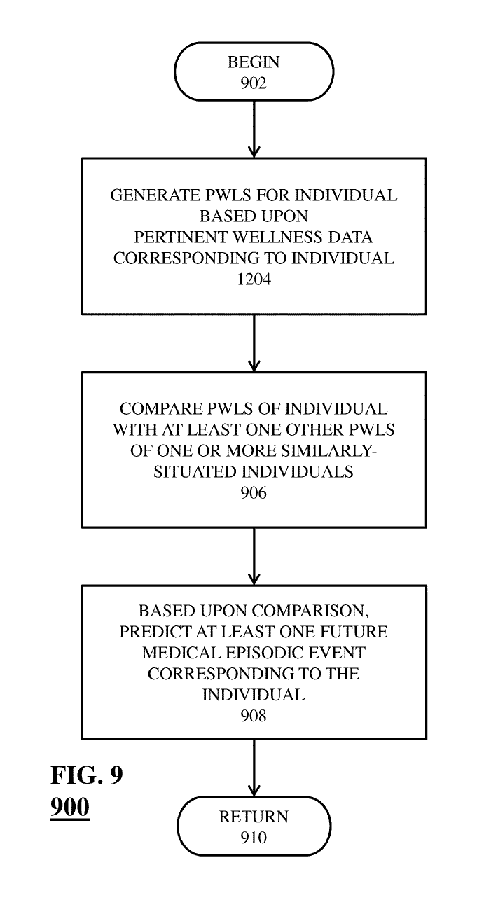

Referring now to FIG. 9, certain method aspects of the invention are illustrated. FIG. 9 is a flowchart of exemplary steps in a computer-implemented method of generating future medical episodic simulations, according to yet another embodiment of the invention.

The method 900 illustratively includes, after the start at block 902, generating a personal wellness lifestyle signature for an individual at block 904. The personal wellness lifestyle signature is based upon pre-selected data pertinent to wellness of the individual, as already described.

The method 900 further illustratively includes comparing the personal wellness lifestyle signature of the individual with at least one personal wellness lifestyle signature of at least one other individual at block 906. The at least one other individual is one determined to have at least one wellness characteristic similar to a corresponding wellness characteristic of the individual. Additionally, the method 900 includes, at block 908, predicting at least one future medical episode corresponding to the individual based upon the comparison. The method illustratively concludes at block 910 and resumes previous processing, including repeating method 900.

According to one embodiment, the method 900 further includes identifying the at least one other individual by determining a statistical correlation between the at least one wellness characteristic of the at least one other individual and the corresponding wellness characteristic of the individual. The step of determining the statistical correlation can comprise computing a value of a correlation coefficient and comparing the computed correlation coefficient to a predetermined level of similarity.

According to still another embodiment, the method 900 further comprises performing at least one data mining step to identify data indicative of the wellness of the individual. Performing the at least one data mining step can comprise performing data mining on one or more data sets comprising at least one among environmental data, lifestyle, medical history data, and medical data.

According to yet another embodiment, the method 900 additionally includes generating a wellness model that models the wellness of the individual. The model so generated according to this step can be based upon at least one among lifestyle history of the individual, medical history of the individual, and past medical episodes of the individual. According to still another embodiment, the method 900 further comprises providing a feedback loop to refine the wellness model. Generating the wellness model can comprise generating a statistical model, according to a particular embodiment. According to this particular embodiment, generating the statistical model can further include determining at least one factor weight.

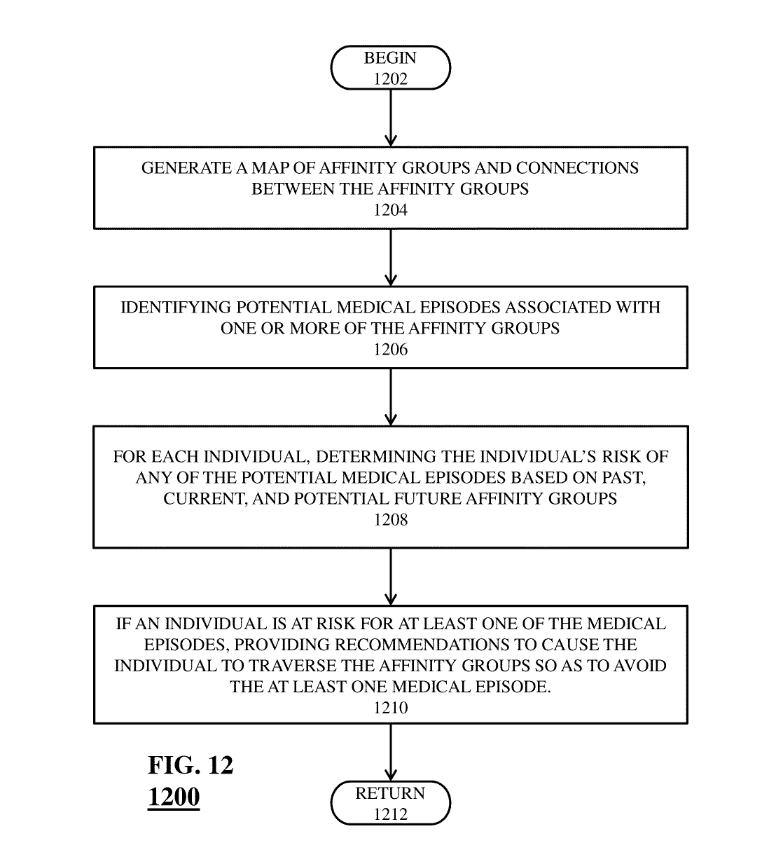

Referring now to FIG. 12, there is shown a flowchart of steps in an exemplary method 1200 for prevention of future medical episode for an individual in accordance with an embodiment of the invention. The method 1200 begins at step 1202 and continues to step 1204. At step 1204, a map of affinity groups and the connections therebetween can be generated for a population. That is, for a particular population of individuals, the ESN can be generated that identifies the episodes or affinity groups associated with the individuals and the available paths or connections between the affinity groups. This ESN can be generated as described above or in accordance with the methods described in International Patent Application No. PCT/US2012/052404, filed Aug. 25, 2012, the contents of which are herein incorporated by reference in their entirety.

Once the map is generated at step 1204, the method 1200 proceeds to step 1206. At step 1206, the medical episodes potentially associated with each affinity group in the map can be identified. For example, as discussed above with respect to FIG. 10, certain locations or a combination of locations can be associated with particular medical episodes. Thus, step 1206 involves not only identifying the medical episodes associated with a particular affinity group, but also the potential medical episodes due to the connections available from the particular affinity group.

After the potential medical episodes are identified at step 1206, the risk of an individual to be associated with a medical episode is determined at step 1208. This can be based on past, present, and/or future affinity groups for the individual. For example, as discussed above with respect to FIG. 10, the presence of an individual at certain locations can increase the risk of Parkinson's or other neurologic conditions. The risk determined at step 1206 can be ascertained based on the methods described above with respect to FIGS. 1-9.

Once the risks are determined at step 1208, the method 1200 proceeds to step 1210. At step 1210, if the individual is at risk for a medical episode, recommendations can be provided to avoid the medical episode. Such recommendations can include explicit recommendations for changes in location, lifestyle, healthcare, etc., as discussed above. However, in some embodiments, the affinity groups can be considered. That is, rather than explicit recommendations, the recommendations can be to proceed along a particular path in the ESN to avoid an affinity group associated with a medical episode or to avoid proceeding along a path in the ESN that leads to a medical episode. Thus, the changes in location, lifestyle, healthcare, etc., are automatically performed by the individual upon following the path.

Once the recommendation is provided at step 1210, the method 1200 can proceed to step 1212 and resume previous processing, including repeating method 1200. For example, the method 1200 can be performed continuously to ensure that the best and most current recommendations are provided to individuals.

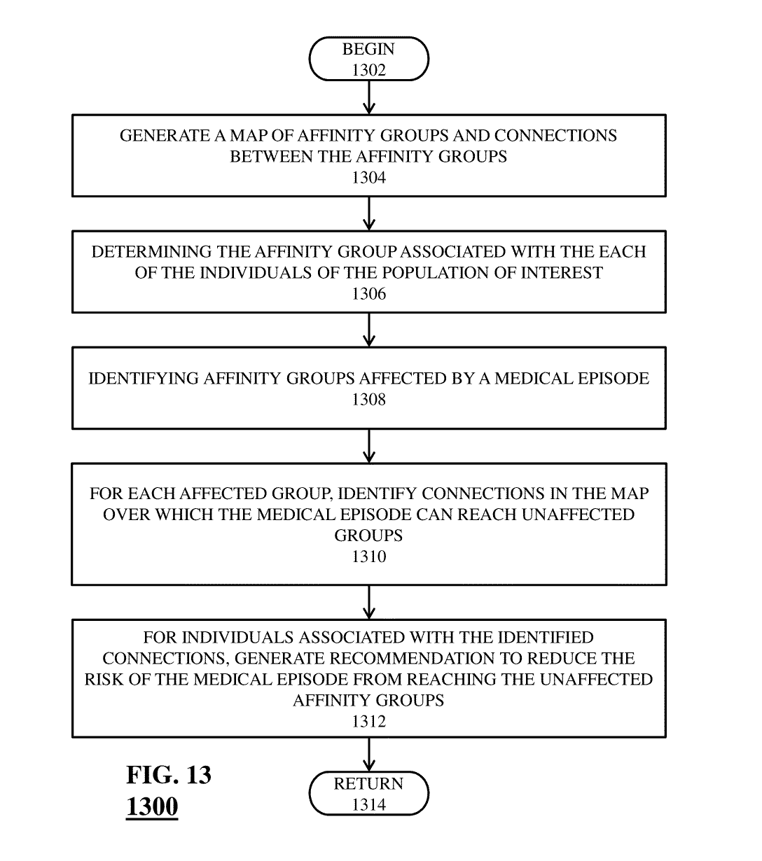

Referring now to FIG. 13, there is shown a flowchart of steps in an exemplary method 1300 for managing a population to prevent or reduce medical episode for an individuals in the population in accordance with an embodiment of the invention. The method 1300 begins at step 1302 and continues to step 1304. At step 1304, a map of affinity groups and the connections therebetween can be generated for a population. That is, for a particular population of individuals, the ESN can be generated that identifies the episodes or affinity groups associated with the individuals and the available paths or connections between the affinity groups. This ESN can be generated as described above or in accordance with the methods described in International Patent Application No. PCT/US2012/052404, filed Aug. 25, 2012, the contents of which are herein incorporated by reference in their entirety.

Once the map of affinity groups is obtained at step 1306, the method 1300 can proceed to step 1306. At step 1306, the affinity groups associated with each of the individuals in the population is obtained. This can include past, current, and future affinity groups. Before, after, or contemporaneously with step 1306, the method 1300 can perform step 1308. At step 1308, the groups currently associated with a medical episode are identified to yield affected groups.

Thereafter, at step 1310, the connections associated with the affected groups are analyzed to determine potential paths or connections by which unaffected groups are connected to affected groups. This steps can involve a determination of individuals with potential paths in the ESN leading from affected groups to unaffected groups, and vice versa, as discussed above with respect to FIG. 11.

Once the potential connections are identified at step 1310, a recommendation can be provided for individuals associated with such potential connections. In some cases, this can involve providing a recommendation in the form of preventative care, warnings, etc. to reduce the risk of an individual from being involved in a medical episode or to prevent the individual from associating others with a medical episode as the individual traverses a path. For example, the recommendation for a individual can be vaccination or treatment to prevent contraction of a disease or spreading of a disease. In other cases, the recommendation can be a particular path along the ESN. For example, a recommendation to follow a path to avoid affected or unaffected affinity groups can be provided. As with method 1200, the path can also be provided to cause the individual to perform tasks to prevent the individual from being associated or associating others with a medical episode. For example, a individual can be recommended a particular mode of travel, a location, or other action that causes the individual to avoid other individual infected with a disease and/or that leads them to preventative care for such a disease. Similarly, the recommended path can be one that causes the individual to avoid other to prevent spread of a disease and/or that leads the individual to treatment.

In methods 1200 and 1300, the recommendations for particular medical episodes can be pre-defined and obtained as needed. For example, a database of recommendations can be provided for particular medical episode. The database can also indicate which conditions can result in a medical episode and/or which conditions can avoid the medical episode. Thus, as these methods are performed, such a database can be accessed to obtain the necessary information for providing appropriate recommendations. These can be incorporated into system 100 of FIG. 1.

Once the recommendation is provided at step 1312, the method 1300 can proceed to step 1314 and resume previous processing, including repeating method 1300. For example, the method 1300 can be performed continuously to ensure that the best and most current recommendations are provided to individuals to continuously monitor medial episodes among affinity groups and avoid expanding a medical episode to other affinity groups.

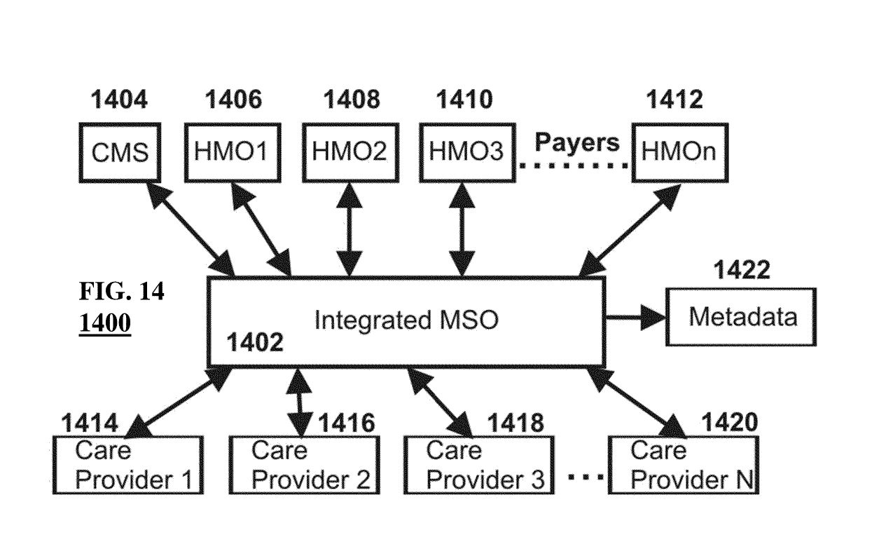

As noted above, the various embodiments of the invention require the collection and aggregation of information from various sources in order to determine affinity groups and identify medical episodes associated with affinity groups. In some embodiments, this can be achieved via a classification of individuals as affinity groups with similar, or identical, Personal Wellness Lifestyle Signatures (PWLS) based on metadata acquired from various entities by one or more organizations. For example, as shown in FIG. 14, various entities can be configured to provide a system 1400 collect, aggregate, and generate information and metadata about individuals.

In the healthcare field, a Managed Service Organization (MSO) is an entity that administers the policies of healthcare payers and determines appropriate payment to healthcare providers. One or more MSOs can thus serve as an intermediary (integrated MSO 1402) between healthcare payers and healthcare providers. Such healthcare payers can include, for example, Combined Medicare/Medicaid Services 1404 or multiple insurance companies, represented in FIG. 14 as Health Management Organizations (HMOs) 1 through n (1406, 1408, 1410, 1412) associated with the integrated MSO 1402. However, the present invention is not limited to HMOs, and any other type of health insurance company, plan, or organization can be utilized in the various embodiments. The healthcare providers can include care providers 1 through N (1414, 1416, 1418, 1420), such as doctors, nurse practitioners, therapists, diagnosticians and the like. In view of these connections, the Integrated MSO can potentially obtain the genetic, diagnostic, remedy, payment, and success information for numerous individuals and interactions and generate the necessary metadata 1422 representing affinity groups, medical episodes, and recommendations. In order to protect individuals' privacy, the metadata 1422 can be redacted or anonymized prior to distribution to third parties.

This metadata 1422 would be in the prediction of results for lifestyle changes, and the efficacy of various pharmaceuticals, diagnostic procedures, and care strategies. Indeed, candidates for specific care plans and experimental therapies could be identified from this data. Clearly, with enough information in the metadata, numerous Personal Wellness Lifestyle Signatures and be configured such that it is possible to analyze trends, causal relationships and potential opportunities for intervention that may not be readily discernable by healthcare providers.

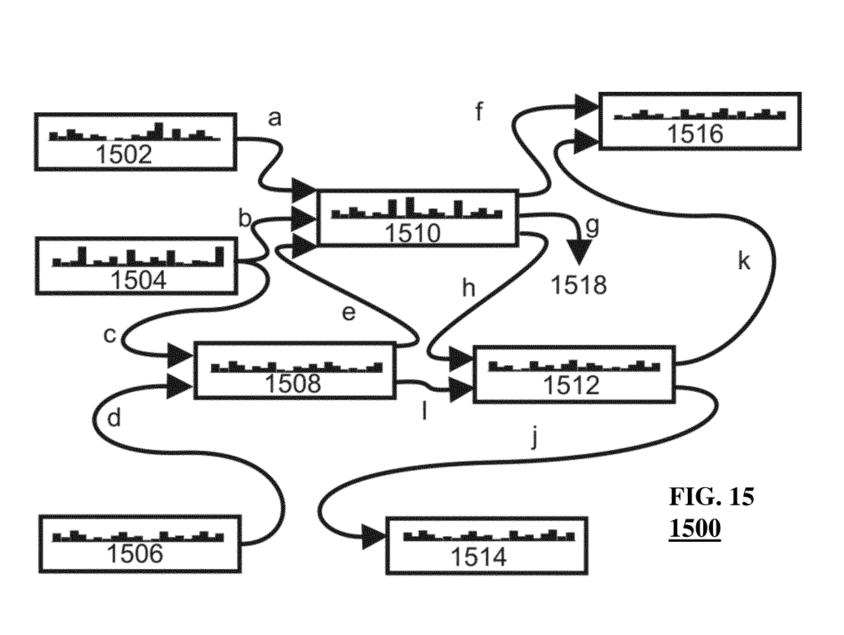

FIG. 15 illustrates an exemplary ESN map 1500 generated in accordance with an embodiment of the invention. Consider three individuals, or groups of individuals segregated by similar, or identical, PWLS's. The top group 1502 is blessed with superior genetics, e.g. well developed immune systems, and a legacy disease resistance, and/or physical, intellectual, and emotional prowess. Their PWLS, shown in FIG. 15 can be generated from their metadata. Other groups with varying degrees of potential are also represented in FIG. 15 as groups 1504 and 1506. They are also identified from the metadata. It can be seen that many of such groups can achieve a wide variety of outcomes based on lifestyle and healthcare decisions. There can be envisioned a complex variety of scenarios that test the potential and decisions of individuals.

For example, individual or group 1502 takes path (a) and enters a competitive and potentially risky scenario to join group 1510 with qualified peers from group 1504 joining along path (b). The scenario might be a war, or academic challenge such as college, or a physical challenge such as amateur or professional sports or a serious illness. Some portion of the group 1504 may elect more preparation and development (i.e., proceed to join group 1508) along path (c) with group 1506 following path (d) to varying degrees of eventual success. Some portion of the preparation and development affinity group 1508 can then elect to join the challenge by joining group 1510 along path (e). Another portion may elect a less demanding challenge and join group 1512 along path (i). Each of the challenge scenarios associated with an affinity group can functions as a filter to separate those who graduate (f) to a high potential group 1516, outright fail (g), or settle (h) for a less demanding scenario and join group 1512.

There will be those who exit the less demanding scenario to be later qualified for a high potential group 1516 along path (k). Some will not be qualified and will take path (j) to a less rewarding of successful scenario and join group 1514. The success or failure of individuals who “filter” out of challenging affinity groups can be associated with their initial PWLS's of incrementally improved or degraded PWLS's that will change as they progress though the Episodal Social Network.

In healthcare, the challenge scenarios may be therapeutic, as care plans, or surgery, or pharmaceutical, or maintenance strategies where success, failure or null outcomes can be associated with various PWLS's and graded by degree of efficacy.

Assume the challenges are specific habitual lifestyle choices. Group 1510 might represent a group of smokers, where some individuals develop serious illness. Affinity group 1516 might represent those who go on to live healthy lives despite a legacy of smoking (f) or because they chose to rehabilitate, by joining group 1512, where some fail (j) and some succeed (k). Those who develop stronger bodies in early life (e.g., group 1508), may have more success later on. The likelihood of success can be associated with the PWLS's and intervention that they choose. The potential can be accurately estimated for a given PWLS's—or set of sequential improvements/degradations in the signature as an individual moves through specific lifestyle choices. The key is that extremely complex networks of choices and potential outcomes can be defined, with simulation of alternatives for any given PWLS.

Although the various embodiments are discussed in terms of healthcare-related aspects, the invention is not limited in this regard. Rather the techniques discussed herein could be adapted to criminal justice, education, career election, or any other scenario in which sequential decisions are utilized.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention has been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-implemented method of advising an individual, the method comprising:
generating a map comprising a plurality of affinity groups for an individual and a plurality of connections between the plurality of affinity groups;
identifying one or more potential medical episodes associated with at least one of the plurality of affinity groups;
detecting a current group of the plurality of affinity groups for the individual;
based on the current group, predicting whether the individual risks at least one of the potential medical episodes based on the current group and one or more paths between the plurality of affinity groups available to the individual from the current group; and
upon determining that the individual risks at least one of the potential medical episodes, delivering instructions for the individual, the instructions configured to cause the individual to avoid the at least one of the potential medical episodes.

2. The method of claim 1, wherein the delivering comprises:
identifying at least one path among the plurality of affinity groups that reduces the risk of the at least one potential medical episode; and
selecting the instructions for the individual to follow based on the at least one path, wherein the instructions are configured for causing the individual to proceed along the at least one path.

3. The method of claim 1, wherein the delivering comprising:
based on the at least one of the potential medical episodes, identifying at least one preventative action for the individual that reduces the risk of at least one potential medical episode for the individual; and
providing instructions to the individual to perform the preventative action.

4. The method of claim 1, wherein the generating comprises:
obtaining data for a plurality of individuals indicating one or more commonalities between the plurality of individuals; and
based on the commonalities, identifying the plurality of affinity groups associated with the plurality of individuals.

5. A system, comprising:
a processor;
a computer-readable medium, having stored thereon a plurality of instructions for causing the processor to perform operations comprising:
generating a map comprising a plurality of affinity groups for an individual and a plurality of connections between the plurality of affinity groups;
identifying one or more potential medical episodes associated with at least one of the plurality of affinity groups;
detecting a current group of the plurality of affinity groups for the individual;
based on the current group, predicting whether the individual risks at least one of the potential medical episodes based on the current group and one or more paths between the plurality of affinity groups available to the individual from the current group; and
upon determining that the individual risks at least one of the potential medical episodes, delivering instructions for the individual, the instructions configured to cause the individual to avoid the at least one of the potential medical episodes.

6. The system of claim 5, wherein the delivering comprises:
identifying at least one path among the plurality of affinity groups that reduces the risk of the at least one potential medical episode; and
selecting the instructions for the individual to follow based on the at least one path, wherein the instructions are configured for causing the individual to proceed along the at least one path.

7. The system of claim 5, wherein the delivering comprises:
based on the at least one of the potential medical episodes, identifying at least one preventative action for the individual that reduces the risk of at least one potential medical episode for the individual; and
providing instructions to the individual to perform the preventative action.

8. The system of claim 5, wherein the generating comprises:
obtaining data for a plurality of individuals indicating one or more commonalities between the plurality of individuals; and
based on the commonalities, identifying the plurality of affinity groups associated with the plurality of individuals.

9. A system, comprising:
a processor;
a computer-readable medium, having stored thereon a plurality of instructions for causing the processor to perform operations comprising:
generating a map comprising a plurality of affinity groups for a plurality of individuals and a plurality of connections between the plurality of affinity groups;
detecting a current group of the plurality of affinity groups for each of the plurality of individuals;
identifying whether at least one of the plurality of affinity groups is currently associated with at least one medical episode to yield at least one affected group;
for each of the at least one affected group, determining at least one potential connection from the plurality of connections over which the at least one medical episode can reach at least one other of the plurality affinity groups not currently associated with the at least one medical episode to yield at least one unaffected group; and
generating at least one recommendation for the at least one of the plurality of individuals associated with the at least one potential connection to reduce the risk of the at least one unaffected group becoming associated with the at least one medical episode.

10. The system of claim 9, wherein the generating further comprises:
identifying one or more preventative actions to reduce the risk of an individual joining the at least one unaffected group from causing the at least one unaffected group becoming associated with the at least one medical episode; and
forwarding at least one recommendation comprising the preventative actions to the at least one of the plurality of individuals associated with the at least one affected group.

11. The system of claim 9, wherein the generating further comprises:
for each of the at least one of the plurality of individuals associated with the at least one potential connection, identifying at least one path among the plurality of affinity groups that reduces the risk of the at least one of the plurality of individuals from causing the at least one unaffected group becoming associated with the at least one medical episode; and
forwarding at least one recommendation to the at least one of the plurality of individuals, the at least one recommendation comprising at least one action configured to direct the at least one of the plurality of individuals along the at least one path.

12. A method for managing a population, the method comprising:
generating a map comprising a plurality of affinity groups for a plurality of individuals and a plurality of connections between the plurality of affinity groups;
detecting a current group of the plurality of affinity groups for each of the plurality of individuals;
identifying whether at least one of the plurality of affinity groups is currently associated with at least one medical episode to yield at least one affected group;
for each of the at least one affected group, determining at least one potential connection from the plurality of connections over which the at least one medical episode can reach at least one other of the plurality affinity groups not currently associated with the at least one medical episode to yield at least one unaffected group; and
generating at least one recommendation for the at least one of the plurality of individuals associated with the at least one potential connection to reduce the risk of the at least one unaffected group becoming associated with the at least one medical episode.

13. The method of claim 12, wherein the generating further comprises:
identifying one or more preventative actions to reduce the risk of an individual joining the at least one unaffected group from causing the at least one unaffected group becoming associated with the at least one medical episode; and
forwarding at least one recommendation comprising the preventative actions to the at least one of the plurality of individuals associated with the at least one affected group.

14. The method of claim 13, wherein the generating further comprises:
for each of the at least one of the plurality of individuals associated with the at least one potential connection,
identifying at least one path among the plurality of affinity groups that reduces the risk of the at least one of the plurality of individuals from causing the at least one unaffected group becoming associated with the at least one medical episode; and
forwarding at least one recommendation to the at least one of the plurality of individuals, the at least one recommendation comprising at least one action configured to direct the at least one of the plurality of individuals along the at least one path.
